(19) United States
(12) Patent Application Publication
(10) Pub. No.: US 2025/0078313 A1
(43) Pub. Date: Mar. 6, 2025

(54) AUTONOMOUS VEHICLE

(71) Applicant: KABUSHIKI KAISHA TOYOTA JIDOSHOKKI, Kariya-shi, Aichi-ken (JP)

(72) Inventor: Takashi UNO, Kariya-shi (JP)

(73) Assignee: KABUSHIKI KAISHA TOYOTA JIDOSHOKKI, Kariya-shi, Aichi-ken (JP)

(21) Appl. No.: 18/282,163

(22) PCT Filed: Mar. 16, 2022
(86) PCT No.: PCT/JP2022/011757

§ 371 Date: Sep. 14, 2023

(30) Foreign Application Priority Data
Mar. 19, 2021 (JP) 2021-046256

(51) Int. Cl. G06T 7/73

(52) U.S. Cl. CPC G06T 7/74; G06T 2207/30252

(57) ABSTRACT

An autonomous vehicle includes a road surface image obtaining device, a memory unit that stores map data, an estimating unit that estimates a self-location, and a determining unit that is configured to execute a reliability determining process of determining a reliability of the self-location. The reliability determining process includes a process of determining whether the estimating unit is in a state capable of estimating the self-location, and a process of determining whether a number of matches between the feature points extracted from the map data and the feature points extracted from the traveling data reaches a predetermined threshold. The determining unit is configured to determine the reliability of the self-location based on results of processes included in the reliability determining process.

### TECHNICAL FIELD

The present disclosure relates to an autonomous vehicle.

### BACKGROUND ART

Patent Literature 1 discloses a method of estimating a self-location of a mobile unit using a road surface image. The movable unit is equipped with a camera for capturing images of the road surface below. The mobile unit estimates the self-location by comparing feature points detected from each of an image captured in advance and an image captured at the present time.

### CITATION LIST

### Patent Literature

Patent Literature 1: Japanese Laid-Open Patent Publication No. 2016-166853

### SUMMARY OF INVENTION

### Technical Problem

Since the method of Patent Literature 1 does not include checking whether the estimated self-location is correct, the reliability of the result of the estimation of the self-location result cannot be guaranteed.

### Solution to Problem

In accordance with one aspect of the present disclosure, an autonomous vehicle includes a road surface image obtaining device, a memory unit, an estimating unit, and a determining unit. The road surface image obtaining device is located on a bottom surface of a vehicle body and is configured to obtain a road surface image. The road surface image is an image of a road surface below the vehicle body. The memory unit stores map data in which positional coordinates and an orientation of the vehicle body are associated with each other. The estimating unit is configured to estimate a self-location by comparing feature points extracted from traveling data and feature points extracted from the map data. The traveling data is the road surface image obtained by the road surface image obtaining device, and the map data being a map image. The determining unit is configured to execute a reliability determining process of determining a reliability of the self-location estimated by the estimating unit. The reliability determining process includes a process of determining whether the estimating unit is in a state capable of estimating the self-location, and a process of determining, in a case in which the self-location can be estimated, whether a number of matches between the feature points extracted from the map data and the feature points extracted from the traveling data when the estimating unit estimates the self-location reaches a predetermined threshold. The determining unit is configured to determine the reliability of the self-location estimated by the estimating unit based on results of processes included in the reliability determining process.

### BRIEF DESCRIPTION OF DRAWINGS

FIG. 1 is a side view of an autonomous vehicle.

FIG. 2 is a block diagram showing an electrical configuration of the autonomous vehicle shown in FIG. 1.

FIG. 3 is a flowchart illustrating a process of determining reliability.

FIG. 4 is a flowchart illustrating a process of determining reliability.

FIG. 5 is a flowchart illustrating a process of determining reliability.

FIG. 6 is a flowchart illustrating a process of determining reliability.

FIG. 7 is a flowchart illustrating a process of determining reliability.

### DESCRIPTION OF EMBODIMENTS

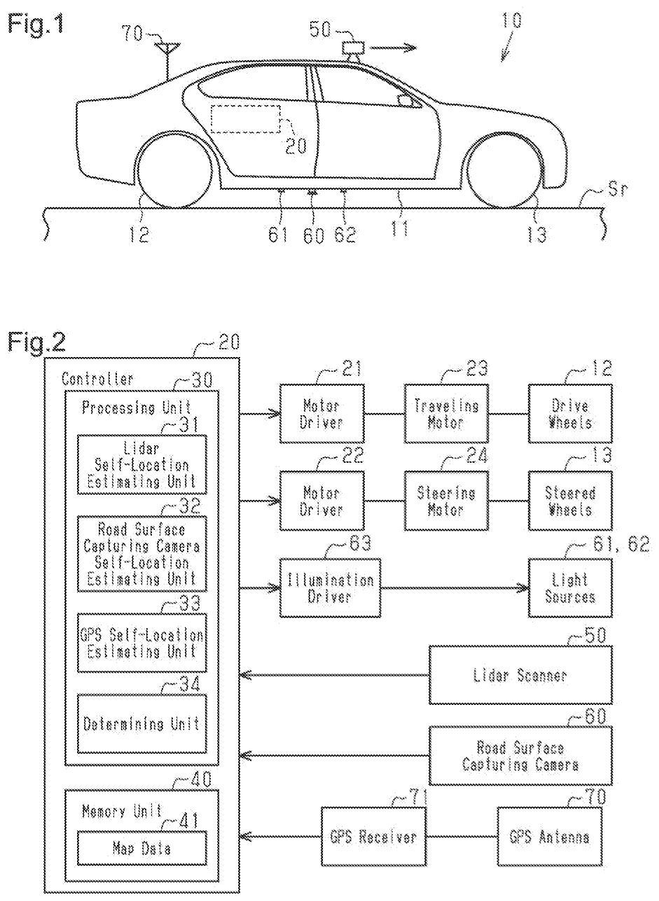

An autonomous vehicle 10 according to an embodiment will now be described with reference to FIGS. 1 to 7.

As shown in FIG. 1, the autonomous vehicle 10 includes a vehicle body 11, two drive wheels 12 disposed at a lower portion of the vehicle body 11, and two steered wheels 13 disposed at the lower portion of the vehicle body 11. The autonomous vehicle 10 travels by rotation of the drive wheels 12 and is steered by changing the direction of the steered wheels 13.

As shown in FIG. 2, the autonomous vehicle 10 includes a controller 20, motor drivers 21, 22, a traveling motor 23, and a steering motor 24. The controller 20 controls the traveling motor 23 through the motor driver 21, thereby driving the drive wheels 12. The controller 20 controls the steering motor 24 through the motor driver 22, thereby actuating the steered wheels 13.

As shown in FIG. 2, the controller 20 includes a processing unit 30 and a memory unit 40. The memory unit 40 stores various programs for controlling the autonomous vehicle 10.

The controller 20 may include dedicated hardware, for example, an application specific integrated circuit (ASIC), that executes at least part of various processes. The controller 20 may be circuitry including one or more processors that operate according to a computer program, circuitry including one or more dedicated hardware circuits such as an ASIC, or a combination thereof. The processor includes a CPU and a memory such as RAM and ROM. The memory stores program code or instructions configured to cause the CPU to execute processes. The memory, or computer-readable medium, includes any type of medium that is accessible by general-purpose computers and dedicated computers.

The controller 20 operates the autonomous vehicle 10 by controlling the traveling motor 23 and the steering motor 24 in accordance with programs stored in the memory unit 40. The autonomous vehicle 10 is not operated by an occupant, and uses the controller 20 to automatically control its travelling and steering.

As illustrated in FIG. 1, the autonomous vehicle 10 includes a light detection and ranging or laser imaging detection and ranging (Lidar) scanner 50 as a data obtaining device for self-location estimation, a road surface capturing camera 60 as a road surface image obtaining device, and a global positioning system (GPS) antenna 70.

The Lidar scanner 50 is installed on an upper surface of the vehicle body 11. The Lidar scanner 50 includes an irradiation unit that irradiates the surroundings of the autonomous vehicle 10 with a laser beam and a light-receiving unit that receives the reflected light. The laser irradiation covers a range of 270 degrees in total, for example, 135 degrees on the right side and 135 degrees on the left side with reference to the traveling direction of the autonomous vehicle 10. The Lidar scanner 50 measures the distance to an object in association with the irradiation angle of the laser while performing scanning. The Lidar scanner 50 may be a two-dimensional type that performs object detection in the horizontal direction or a three-dimensional type that performs object detection in the horizontal direction and the vertical direction.

As shown in FIG. 2, the Lidar scanner 50 is connected to the controller 20. The controller 20 receives measurement data obtained by the Lidar scanner 50. As a result, the controller 20 can detect the distance to an object present in the surroundings by measuring the time from the irradiation of the laser to the reception of the laser. That is, the controller 20 can grasp the surrounding environment of the autonomous vehicle 10.

As shown in FIGS. 1 and 2, the road surface capturing camera 60 is installed on the lower surface of the vehicle body 11. The road surface capturing camera 60 captures images of a road surface Sr below the vehicle body 11. The autonomous vehicle 10 includes light sources 61, 62 for illumination and an illumination driver 63. The light sources 61, 62 are installed on the lower surface of the vehicle body 11 so as to surround the road surface capturing camera 60. The light sources 61, 62 are, for example, light-emitting diodes. The controller 20 controls light sources 61, 62 via the illumination driver 63. The light sources 61, 62 are turned on in synchronization with the image capturing timing of the road surface capturing camera 60. The turned on light sources 61, 62 irradiates an image capturing region of the road surface capturing camera 60.

As shown in FIG. 1, the GPS antenna 70 is installed on the upper surface of the vehicle body 11. The GPS antenna 70 receives radio waves from artificial satellites. As shown in FIG. 2, the autonomous vehicle 10 is equipped with a GPS receiver 71. The GPS antenna 70 is connected to the controller 20 via the GPS receiver 71. The controller 20 receives survey information obtained by the GPS antenna 70.

As illustrated in FIG. 2, the processing unit 30 of the controller 20 includes a Lidar self-location estimating unit 31 (hereinafter referred to as a first estimating unit 31), a road surface capturing camera self-location estimating unit 32 (hereinafter referred to as a second estimating unit 32), and a GPS self-location estimating unit 33 (hereinafter referred to as a third estimating unit 33).

The memory unit 40 stores surrounding environment data as map data 41. The surrounding environment data is created in a state of being associated with geographical location information. The memory unit 40 stores, as the map data 41, a map image. The map image is an image of the road surface Sr that is captured beforehand. The map image is created while being associated with geographical location information. As described above, the autonomous vehicle 10 includes the memory unit 40, which is installed on the vehicle body 11 and stores the map data 41 in which the position coordinates and the orientation of the vehicle body 11 are associated with each other.

The first estimating unit 31 estimates the self-location of the autonomous vehicle 10 by comparing feature points extracted from the surrounding environment data with feature points extracted from the map data 41 in the memory unit 40. The surrounding environment data is measured by the Lidar scanner 50. The self-location includes the position coordinates and the orientation of the vehicle body 11. The position coordinates of the vehicle body 11 are coordinates indicating one point on the vehicle body 11 and are, for example, coordinates at the installation position of the Lidar scanner 50 in the horizontal direction of the vehicle body 11. Specifically, the first estimating unit 31 detects feature points from the surrounding environment at the current point in time, and detects feature amounts of the feature points, that is, feature amounts representing the magnitude of luminance around the feature points. Similarly, the first estimating unit 31 detects feature points from the map data 41, which has been obtained in advance, and detects feature amounts of the feature points, that is, feature amounts representing the degrees of the magnitude of the luminance around the feature point. Then, the first estimating unit 31 estimates the self-location of the autonomous vehicle 10 by comparing the feature amount of each feature point in the surrounding environment at the current point in time with the feature amount of each feature point in the map data 41 obtained in advance.

The map data 41 may be stored in the memory unit 40 in advance. In this case, the coordinates of the surrounding environment are stored as an environment map. The environment map is generated by simultaneous localization and mapping (SLAM). SLAM simultaneously performs self-location estimation of a movable body and generates an environment map, and allows a movable body to generate an environment map under an unknown environment. The constructed map information is used to perform specific tasks. When performing self-location estimation, the estimating unit 31 estimates the self-location of the autonomous vehicle 10 by comparing the surrounding environment obtained by the Lidar scanner 50 with the map data 41 obtained in advance.

The second estimating unit 32 estimates the self-location of the autonomous vehicle 10 by comparing feature points extracted from traveling data with feature points extracted from the map data 41 in the memory unit 40. The traveling data is an image of the road surface Sr captured by the road surface capturing camera 60. The self-location includes the position coordinates and the orientation of the vehicle body 11. The position coordinates of the vehicle body 11 are coordinates indicating one point on the vehicle body 11 and are, for example, coordinates at the installation position of the road surface capturing camera 60 in the horizontal direction of the vehicle body 11. Specifically, the second estimating unit 32 detects feature points from an image that is the road surface image at the current point in time, and detects feature amounts of the feature points, that is, feature amounts representing the magnitude of luminance at pixels around pixels having the feature points. Similarly, the second estimating unit 32 detects feature points from a map image that has been captured in advance, and detects feature amounts of the feature points, that is, feature amounts representing the magnitude of luminance at pixels around pixels having the feature points. Then, the second estimating unit 32 estimates the self-location of the autonomous vehicle 10 by comparing the feature amount of each feature point in the road surface image at the current point in time with the feature amount of each feature point in the map image captured in advance.

The map data (map image) 41 may be stored in the memory unit 40 in advance. In this case, the coordinates of patterns on the road surface Sr are stored as an environment map. The environment map is generated by simultaneous localization and mapping (SLAM). SLAM simultaneously performs self-location estimation of a movable body and generates an environment map, and allows a movable body to generate an environment map under an unknown environment. The constructed map information is used to perform specific tasks. When performing self-location estimation, the second estimating unit 32 estimates the self-location of the autonomous vehicle 10 by comparing the road surface image obtained by a camera with the map image obtained in advance.

The third estimating unit 33 estimates the self-location of the autonomous vehicle 10 from the survey information obtained by the GPS antenna 70. The self-location includes the position coordinates and the orientation of the vehicle body 11. The position coordinates of the vehicle body 11 are coordinates indicating one point on the vehicle body 11 and are, for example, coordinates at the installation position of the GPS antenna 70 in the horizontal direction of the vehicle body 11.

The controller 20 controls the traveling motor 23 and the steering motor 24 while performing self-location estimation to estimate the location of the autonomous vehicle 10 on the map. This makes it possible to move the autonomous vehicle 10 to a desired location.

The autonomous vehicle 10 is configured to execute a reliability determining process of determining the reliability of the estimated self-location. The autonomous vehicle 10 determines the reliability of the self-location estimated by the second estimating unit 32. The reliability determining process is executed by a determining unit 34 included in the processing unit 30.

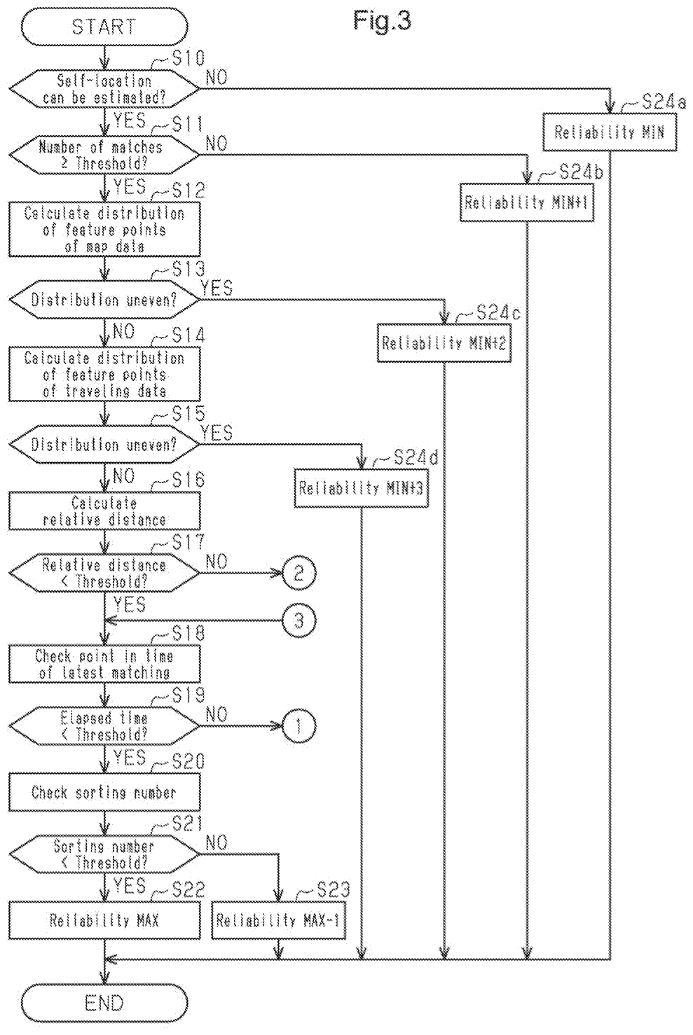

Hereinafter, with reference to FIGS. 3 to 7, the reliability determining process of determining the reliability of the self-location, which is executed on the autonomous vehicle 10 according to the present embodiment, will be described together with operation thereof.

In step S10, the determining unit 34 determines whether the second estimating unit 32 is estimating the self-location in a state in which the second estimating unit 32 is capable of estimating the self-location. More specifically, the determining unit 34 compares feature points extracted from the image of the road surface Sr with feature points extracted from the map data 41. After such feature point matching process, the determining unit 34 determines whether the number of matches from which outliers have been removed is greater than or equal to a specified number. The outlier removal may be performed by, for example, least median of squares (LMedS) and random sample consensus (RANSAC). When the number of matches is greater than or equal to the specified number, the determining unit 34 determines that the self-location estimation is possible and proceeds to step S11. When the number of matches is less than the specified number, the determining unit 34 determines that the self-location estimation is not possible and proceeds to step S24a.

When proceeding to step S24a, the determining unit 34 determines the reliability of the self-location estimated by the second estimating unit 32 as reliability MIN. The reliability MIN is the lowest reliability as a level of reliability determined by the determining unit 34. The determining unit 34 that has determined the reliability MIN in step S24a ends the process of determining the reliability of the self-location.

When proceeding to step S11, the determining unit 34 determines whether the number of matches at the time the second estimating unit 32 estimates the self-location is greater than or equal to a predetermined threshold. The threshold used in step S11 is set to a number of matches that meets a target value of accuracies in traveling and stopping, separately from thresholds used in processes in other steps. The target value is determined depending on, for example, the type of the autonomous vehicle 10 or the location in which the autonomous vehicle 10 travels. When the number of matches is greater than or equal to the threshold, the determining unit 34 proceeds to step S12. When the number of matches is less than the threshold, the determining unit 34 proceeds to step S24b and determines that the reliability of the estimated self-location is reliability MIN+1. The reliability MIN+1 is one level higher than the reliability MIN. After the process of step S24b, the determining unit 34 ends the process of determining the reliability of the self-location.

When proceeding to step S12, the determining unit 34 calculates the distribution of the feature points of the map data 41, from which the feature points were extracted when the second estimating unit 32 estimated the self-location. Subsequently, in step S13, the determining unit 34 determines whether the calculated distribution of the feature points of the map data 41 is uneven. When the distribution of feature points is uneven, there is a possibility that matching is established with incorrect feature points, and thus the processes of steps S12, S13 are executed to determine whether the distribution is uneven. When the distribution of the feature points is not uneven, the determining unit 34 proceeds to step S14. The determining unit 34 determines that the distribution is not uneven when the feature points are not detected in a concentrated manner in a portion where the pixel values of the map image, which is the map data 41, are low. On the other hand, when the distribution of the feature points is uneven, the determining unit 34 proceeds to step S24c and determines that the reliability of the estimated self-location is reliability MIN+2. The reliability MIN+2 is one level higher than the reliability MIN+1. The determining unit 34 determines that the distribution is uneven when the feature points are detected in a concentrated manner in a portion where the pixel values of the map image, which is the map data 41, are low. After the process of step S24c, the determining unit 34 ends the process of determining the reliability of the self-location.

When proceeding to step S14, the determining unit 34 calculates the distribution of the feature points of the traveling data, from which the feature points were extracted when the second estimating unit 32 estimated the self-location. Subsequently, in step S15, the determining unit 34 determines whether the calculated distribution of the feature points of the traveling data is uneven. When the distribution of feature points is uneven, there is a possibility that matching is established with incorrect feature points, and thus the processes of steps S14, S15 are executed to determine whether the distribution is uneven. When the distribution of the feature points is not uneven, the determining unit 34 proceeds to step S16. The determining unit 34 determines that the distribution is not uneven when the feature points are not detected in a concentrated manner in a portion where the pixel values of the image of the road surface Sr, which is the traveling data, are low. On the other hand, when the distribution of the feature points is uneven, the determining unit 34 proceeds to step S24d and determines that the reliability of the estimated self-location is reliability MIN+3. The reliability MIN+3 is one level higher than the reliability MIN+2. The determining unit 34 determines that the distribution is uneven when the feature points are detected in a concentrated manner in a portion where the pixel values of the image of the road surface Sr, which is the traveling data, are low. After the process of step S24d, the determining unit 34 ends the process of determining the reliability of the self-location.

When proceeding to step S16, the determining unit 34 calculates a relative distance between the road surface image and the map image at the time the second estimating unit 32 performed the matching process. Subsequently, the determining unit 34 determines whether the relative distance calculated in step S17 is less than a threshold. The threshold used in step S17 is determined separately from the thresholds used in processes of other steps. The threshold used in step S17 is a value corresponding to distances set to a value greater than or equal to half of the effective range of the image. When the relative distance is less than the threshold, the determining unit 34 proceeds to step S18. When the relative distance is greater than or equal to the threshold, the determining unit 34 proceeds to step S29 in FIG. 5. The relative distance being less than the threshold corresponds to the relative distance between the road surface image and the map image being relatively short.

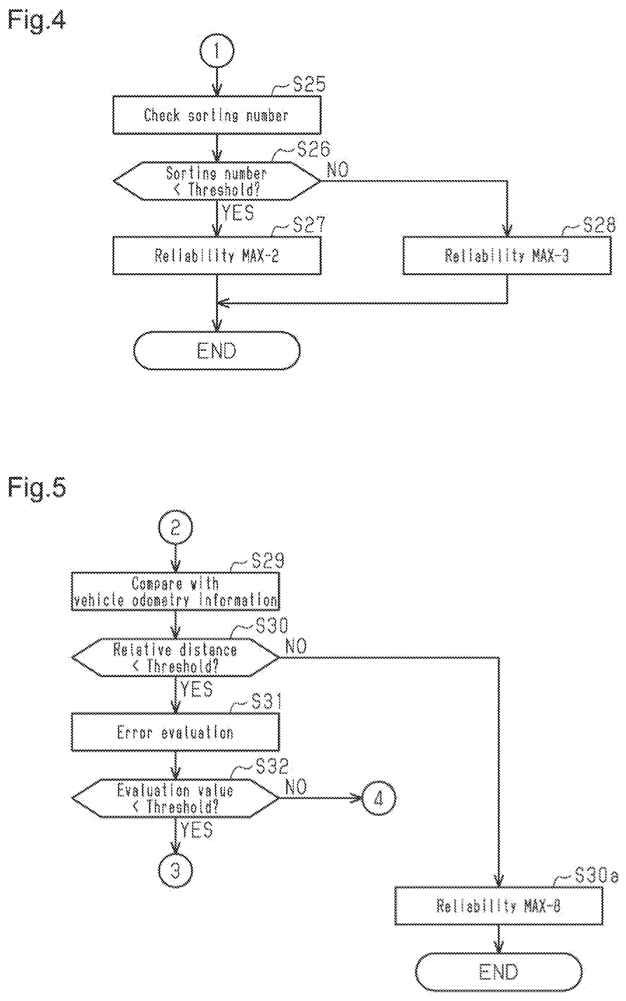

When proceeding to step S18, the determining unit 34 checks the latest point in time of matching performed by the second estimating unit 32. Subsequently, in step S19, the determining unit 34 determines whether elapsed time is shorter than a threshold. The elapsed time refers to the difference between the point in time of the previous matching and the point in time of the latest matching. The point in time of the previous matching process is stored in the memory unit 40. The threshold used in step S19 is determined separately from the thresholds used in processes of other steps. The threshold used in step S19 corresponds to time calculated by comparing the difference between the point in time of the previous matching process and the point in time of the latest matching process with the sampling time at the time the road surface image was obtained. When the elapsed time is shorter than the threshold, the determining unit 34 proceeds to step S20. When the elapsed time is longer than or equal to the threshold, the determining unit 34 proceeds to step S25 in FIG. 4.

When proceeding to step S20, the determining unit 34 checks a sorting number assigned to the map image in which matching is established. Subsequently, in step S21, the determining unit 34 determines whether the checked sorting number is less than a threshold. Multiple map images are stored as the map data 41. An identification number for identifying the image is attached to each map image. The determining unit 34 rearranges the map images in order of closeness to the latest self-location. By rearranging the map images, the priority order of the map images to be compared in the matching process for estimating the self-location is determined. The rearranged map images are given sorting numbers in accordance with the order of priority.

In step S20, the determining unit 34 checks the sorting number of the map image in which matching is established in accordance with the priory order of the rearranged map images. The determining unit 34 proceeds to step S22 when the sorting number of the map image in which matching is established is less than a threshold in step S21. In contrast, the determining unit 34 proceeds to step S23 when the sorting number of the map image in which matching is established is less than the threshold in step S21. The threshold used in step S21 is determined separately from the thresholds used in processes of other steps. The threshold used in step S21 is, for example, 3 as a sorting number, and corresponds to an order that is determined such that it is possible to check whether matching is established near the map image having the highest priority order. In step S21, when matching is established in the first to the third map images among the rearranged map images, the determining unit 34 determines that matching is established in map images with high priority orders and determines that the reliability is high. In step S21, when matching is not established in the first to the third map images among the rearranged map images, the determining unit 34 determines that matching is established in map images with low priority orders and determines that the reliability is low. When matching is not established in map images with high priority orders despite the rearrangement of the map images, it is considered that there is an error in the latest self-location or there is an error in the location associated with the map images.

When proceeding to step S22, the determining unit 34 determines that the reliability of the self-location estimated by the second estimating unit 32 is reliability MAX. The reliability MAX is the highest reliability as a level of reliability determined by the determining unit 34. When proceeding to step S23, the determining unit 34 determines that the reliability of the self-location estimated by the second estimating unit 32 is reliability MAX-1, which is one level lower than the reliability MAX. After the process of step S22 or step S23, the determining unit 34 ends the process of determining the reliability of the self-location.

When proceeding from step S19 to step S25 in FIG. 4, the determining unit 34 executes the processes of steps S25, S26. The processes of steps S25, S26 are the same as the processes of steps S20, S21 in FIG. 3. When proceeding to step S27, the determining unit 34 determines that the reliability of the self-location estimated by the second estimating unit 32 is reliability MAX-2, which is two levels lower than the reliability MAX. When proceeding to step S28, the determining unit 34 determines that the reliability of the self-location estimated by the second estimating unit 32 is reliability MAX-3, which is three levels lower than the reliability MAX. After the process of step S27 or step S28, the determining unit 34 ends the process of determining the reliability of the self-location.

When proceeding from step S17 to step S29 in FIG. 5, the determining unit 34 compares the self-location estimated by the second estimating unit 32 with vehicle odometry information. The vehicle odometry information is calculated by estimating the movement amount using the number of rotations of the traveling motor 23. The vehicle odometry information is calculated by the processing unit 30. Subsequently, in step S30, the determining unit 34 determines whether the relative distance between the self-location estimated by the second estimating unit 32 and the self-location based on the vehicle odometry information is less than a predetermined threshold. The threshold used in step S30 is determined separately from the threshold used in step S17, which is also used for comparison of a relative distance. The threshold used in step S30 corresponds to distances set to value greater than or equal to the effective range of the image. When the relative distance is less than the threshold, the determining unit 34 proceeds to step S31. When the relative distance is greater than or equal to the threshold, the determining unit 34 proceeds to step S30a. In step S30a, the determining unit 34 determines that the reliability of the estimated self-location is a reliability MAX-8, which is eight levels lower than the reliability MAX. The reliability MAX-8 is higher than the reliability MIN+3. After the process of step S30a, the determining unit 34 ends the process of determining the reliability of the self-location.

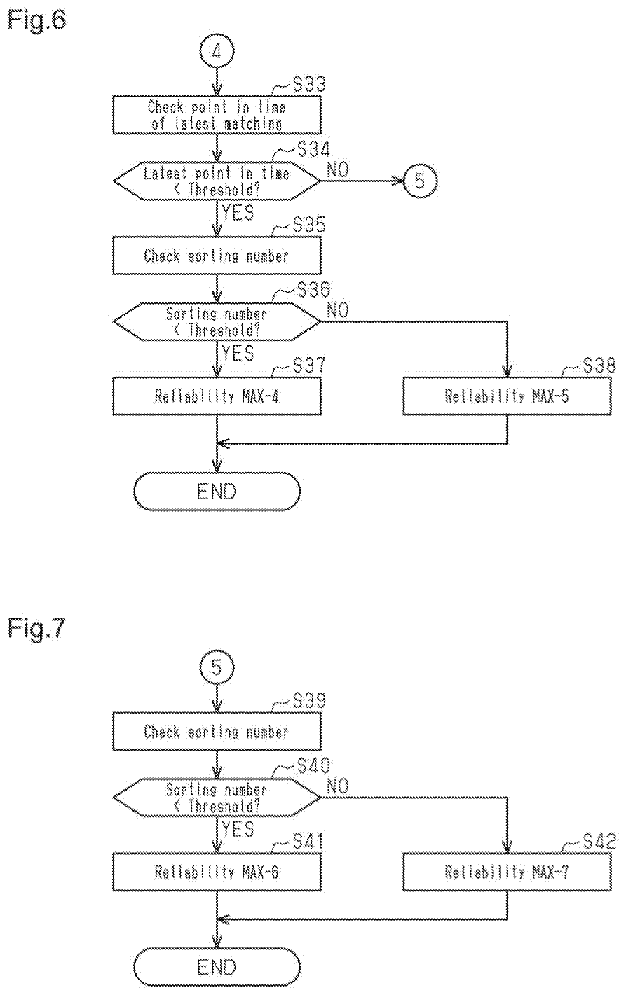

When proceeding to step S31, the determining unit 34 performs error evaluation. In the error evaluation, the accuracy of the self-location is calculated based on variation in the accuracy of the map measurement and the relative distance. Subsequently, in step S32, the determining unit 34 determines whether an evaluation value of the error evaluation is less than a threshold. The threshold used in step S32 is determined separately from the thresholds used in processes of other steps. The threshold used in step S32 is set to any desired accuracy of the target self-location. When the evaluation value is less than the threshold, the determining unit 34 proceeds to step S18 in FIG. 3 and executes the subsequent processes. When the process proceeds to step S18 through steps S29 to S32, the estimation of the self-location based on the vehicle odometry achieves a favorable result. It is thus determined that errors of the estimation result of the self-location using images are small. When the evaluation value is greater than or equal to the threshold, the determining unit 34 proceeds to step S33 in FIG. 6.

When proceeding to step S33 in FIG. 6, the determining unit 34 executes the subsequent processes. The processes of steps S33 to S36 are the same as the processes of steps S18 to S21 in FIG. 1. When proceeding to step S37 via step S36, the determining unit 34 determines that the reliability of the self-location estimated by the second estimating unit 32 is reliability MAX-4, which is four levels lower than the reliability MAX. When proceeding to step S38 via step S36, the determining unit 34 determines that the reliability of the self-location estimated by the second estimating unit 32 is reliability MAX-5, which is five levels lower than the reliability MAX. After the process of step S37 or step S38, the determining unit 34 ends the process of determining the reliability of the self-location.

When proceeding from step S34 to step S39 in FIG. 7, the determining unit 34 executes the subsequent processes. The processes of steps S39, S40 are the same as the processes of steps S20, S21 in FIG. 1. When proceeding to step S41 via step S40, the determining unit 34 determines that the reliability of the self-location estimated by the second estimating unit 32 is reliability MAX-6, which is six levels lower than the reliability MAX. When proceeding to step S42 via step S40, the determining unit 34 determines that the reliability of the self-location estimated by the second estimating unit 32 is reliability MAX-7, which is seven levels lower than the reliability MAX. After the process of step S41 or step S42, the determining unit 34 ends the process of determining the reliability of the self-location.

As described above, the reliability of the self-location estimated by the second estimating unit 32 is determined in stages. Specifically, an index for calculating the reliability is obtained from the map data 41 and the traveling data, and is compared with a threshold to determine the reliability in stages using a combination of items meeting conditions. The reliability can be defined in thirteen stages, for example, namely, the reliability MAX, the reliability MAX-1, . . . , the reliability MAX-8, the reliability MIN+3, the reliability MIN+2, the reliability MIN+1, and the reliability MIN. The reliability MIN+3 is nine levels lower than the reliability MAX. The reliability MIN+2 is ten levels lower than the reliability MAX. The reliability MIN+1 is eleven levels lower than the reliability MAX. The reliability MIN is twelve levels lower than the reliability MAX.

The processing unit 30 reflects the determined reliability on the self-location estimation. The following two methods are possible methods for reflecting the determined reliability. The processing unit 30 is configured to reflect the determined reliability by either method.

The first method adjusts a weighting parameter for integration with other measurement results and estimation values based on the reliability. Examples of other measurement results and estimation values include a measurement result and an estimation value of the first estimating unit 31 or a measurement result and an estimation value of the third estimating unit 33. As the reliability of the self-location estimated by the second estimating unit 32 increases, the processing unit 30 increases the weight of the result of the self-location estimation in the second estimating unit 32. On the other hand, when the reliability of the self-location estimated by the second estimating unit 32 is relatively low, the processing unit 30 increases the weight of the result of the self-location estimation by the first estimating unit 31 and the result of the self-location estimation by the third estimating unit 33. When the reliability of the self-location estimated by the second estimating unit 32 is relatively low, the second method switches the self-location to be referred to when the autonomous vehicle 10 travels to the self-location estimated by the first estimating unit 31 or the third estimating unit 33.

The above-described embodiment has the following advantages.
(1) The processing unit 30 of the autonomous vehicle 10 determines the reliability of the self-location estimated by the second estimating unit 32 through multiple processes. This provides a mechanism capable of ensuring the reliability of the self-location result estimated by the autonomous vehicle 10.
(2) Since the reliability of the self-location is determined in stages and the reliability is calculated in stages based on the determination result, the reliability of the self-location estimated by the second estimating unit 32 is finely calculated.
(3) The reliability of the self-location estimated by the second estimating unit 32 is reflected in the self-location estimation in the autonomous vehicle 10. That is, for example, when the reliability of the self-location estimated by the second estimating unit 32 is relatively low, the estimation result of the first estimating unit 31 or the third estimating unit 33 is reflected in the self-location estimation in the autonomous vehicle 10. This improves the overall reliability of the self-location result estimated by the autonomous vehicle 10. As a result, malfunction of the system related to autonomous traveling is prevented. Further, since the control performance is improved, the reliability of the entire system is improved.

The above-described embodiment may be modified as follows. The above-described embodiment and the following modifications can be combined as long as the combined modifications remain technically consistent with each other.

The order of determinations of the steps for determining the reliability may be changed.

The thresholds used to determine the reliability may be changed. That is, the thresholds may be changed if they are determined based on desired accuracy of the self-location.

If the relative distance is greater than or equal to the threshold in the process of step S17, the process may proceed to step S30a to determine that the reliability is MAX-8.

The road surface image obtaining device is not limited to the camera 60. For example, linear sensors (linear image sensors) may be used as the road surface image obtaining device.

The merging method (integration method) based on the reliability is not limited. In addition to the sum of weights, a Kalman filter may be used.

1. An autonomous vehicle, comprising:
a road surface image obtaining device that is located on a bottom surface of a vehicle body and is configured to obtain a road surface image, the road surface image being an image of a road surface below the vehicle body;
a memory unit that stores map data in which positional coordinates and an orientation of the vehicle body are associated with each other;
an estimating unit that is configured to estimate a self-location by comparing feature points extracted from traveling data and feature points extracted from the map data, the traveling data being the road surface image obtained by the road surface image obtaining device, and the map data being a map image; and
a determining unit that is configured to execute a reliability determining process of determining a reliability of the self-location estimated by the estimating unit, wherein
the reliability determining process includes:
a process of determining whether the estimating unit is in a state capable of estimating the self-location; and
a process of determining, in a case in which the self-location can be estimated, whether a number of matches between the feature points extracted from the map data and the feature points extracted from the traveling data when the estimating unit estimates the self-location reaches a predetermined threshold, and
the determining unit is configured to determine the reliability of the self-location estimated by the estimating unit based on results of processes included in the reliability determining process.

2. The autonomous vehicle according to claim 1, wherein
the reliability determining process further includes:
a process of determining whether a distribution of the feature points extracted from the map data is uneven; and
a process of determining whether a distribution of the feature points extracted from the traveling data is uneven.

3. The autonomous vehicle according to claim 1, wherein the reliability determining process further includes a process of determining whether a relative distance between the map image and the road surface image when the estimating unit performs matching is less than a predetermined threshold.

4. The autonomous vehicle according to claim 3, wherein the reliability determining process further includes a process of determining, in a case in which the relative distance between the map image and the road surface image is greater than or equal to the predetermined threshold, whether a relative distance between the self-location estimated by the estimating unit and a self-location based on vehicle odometry information is less than a predetermined threshold.

5. The autonomous vehicle according to claim 1, wherein the reliability determining process further includes a process of determining whether an elapsed time is shorter than a predetermined threshold, the elapsed time being a difference between a previous point in time at which the estimating unit performed matching and a current point in time at which the estimating unit performed the matching.

6. The autonomous vehicle according to claim 1, wherein the reliability determining process further includes a process of determining whether the map image in which matching is established when the estimating unit estimates the self-location is a map image having a priority lower than a predetermined threshold among map images to be subjected to matching.
